(19) United States
(12) Patent Application Publication
(10) Pub. No.: US 2005/0182770 A1
(43) Pub. Date: Aug. 18, 2005

(54) Assigning geographic location identifiers to web pages

(76) Inventors: Lars Eilstrup Rasmussen, Berkeley, CA (US); Jens Eilstrup Rasmussen, Berkeley, CA (US)

Correspondence Address: HARRITY & SNYDER, LLP, 11240 WAPLES MILL ROAD, SUITE 300, FAIRFAX, VA, 22030, US

(21) Appl. No.: 10/996,602

(22) Filed: Nov. 26, 2004

Related U.S. Application Data
(60) Provisional application No. 60/525,400, filed on Nov. 25, 2003.

(51) Int. Cl. G06F 17/30

(52) U.S. Cl. 707/10

(57) ABSTRACT

A system and method for assigning geographic location identifiers to web documents may include identifying a set of web documents. A geographic location identifier included within a first web document in the set of web documents may be identified. The identified geographic location identifier may be assigned to a second web document in the set of web documents based on a relevancy of the first web document to the second web document.

### CROSS-REFERENCE TO RELATED APPLICATION

The present application claims priority to U.S. Provisional Patent Application No. 60/525,400, filed Nov. 25, 2003, the entirety of which is incorporated by reference herein.

### FIELD OF THE INVENTION

Implementations consistent with the principles of the invention relate generally to providing items, and more specifically, to assigning geographic locations to the provided items.

### BACKGROUND OF THE INVENTION

The World Wide Web (“web”) contains a vast amount of information. Locating a desired portion of the information, however, can be challenging. This problem is compounded because the amount of information on the web and the number of new users inexperienced at web searching are growing rapidly.

Search engines attempt to return hyperlinks to web pages in which a user is interested. Generally, search engines base their determination of the user's interest on search terms (called a search query) entered by the user. The goal of the search engine is to provide links to high quality, relevant results (e.g., web pages) to the user based on the search query. Typically, the search engine accomplishes this by matching the terms in the search query to a corpus of pre-stored web pages. Web pages that contain the user's search terms are “hits” and are returned to the user as links.

In an attempt to increase the relevancy and quality of the web pages returned to the user, a search engine may attempt to sort the list of hits so that the most relevant and/or highest quality pages are at the top of the list of hits returned to the user. For example, the search engine may assign a rank or score to each hit, where the score is designed to correspond to the relevance or importance of the web page.

Unfortunately, general keyword-based search engines are not always suitable for finding web pages associated with establishments within a specific geographic area or region. Such web searching fails primarily because keyword-based search engines typically cannot assign an address or other geographically descriptive information to those web pages not actually including such information.

Several attempts have been made to geographically define web pages for use by search engines. In one attempt, a search engine is configured to maintain a central database binding URLs to one or more geographic locations. In this scenario, search engine owners manually assign locations to web sites, and/or make available to web site authors mechanisms by which they can explicitly request locations be assigned to their web sites. Alternatively, the search engine may define a set of HTML meta-tags with which web site authors can explicitly assign one or more geographic locations directly to each of their web pages. Unfortunately, it has been found that requiring web site authors or search engine owners to explicitly assign locations to web pages has not proven workable.

A third method includes configuring a search engine to parse existing postal addresses or other geographic information from web pages, and allow users to search for web pages that contain both certain keywords and at least one postal address within or close to a given geographic region. Unfortunately, this concept remains of limited use because relevant postal addresses often do not appear on the same web page as do the relevant search keywords.

Thus, there is a need in the art for methods and systems for accurately assigning geographic location identifiers to documents.

### SUMMARY OF THE INVENTION

In accordance with one aspect, a method may include identifying a set of web documents; identifying geographic location identifiers included within at least some of the plurality of web documents; assigning the identified geographic location identifiers to web documents that include the identified geographic location identifiers; and assigning the identified geographic location identifiers to other web documents based on a relevancy of the web documents including a geographic location identifier to the other web documents.

According to another aspect, a system may include means for identifying a set of web documents; means for identifying a geographic location identifier included within a first geographic document in the plurality of web documents; and means for assigning the identified geographic location identifier to a second web document in the plurality of web documents that based on a relevancy of the first web document to the second web document.

### BRIEF DESCRIPTION OF THE DRAWINGS

The accompanying drawings, which are incorporated in and constitute a part of this specification, illustrate an implementation of the invention and, together with the description, explain the invention. In the drawings,

FIG. 1 is an exemplary diagram of a network in which systems and methods consistent with the principles of the invention may be implemented;

FIG. 2 is an exemplary diagram of a client or server according to an implementation consistent with the principles of the invention;

FIG. 3 is a block diagram illustrating an implementation of an exemplary search engine;

FIG. 4 is a network graph of nodes, such as web sites, indexed by the search engine shown in FIG. 1;

FIG. 5 is a flow diagram of an exemplary process for assigning geographic identification information to web pages included within search results provided to a client in an implementation consistent with the principles of the invention;

FIG. 6 is a flow diagram of an exemplary process for standardizing and assigning geographic location identifiers to a collection of web pages in an implementation consistent with the principles of the invention;

FIG. 7 is a flow diagram of an exemplary process for assigning geographic location identifiers to a collection of web pages in an implementation consistent with the principles of the invention;

FIG. 8 is a flow diagram of another exemplary process for assigning geographic location identifiers to a collection of web pages in an implementation consistent with the principles of the invention; and

FIG. 9 is a flow diagram of yet another exemplary process for assigning geographic location identifiers to a collection of web pages in an implementation consistent with the principles of the invention.

### DETAILED DESCRIPTION

The following detailed description of implementations consistent with the principles of the invention refers to the accompanying drawings. The same reference numbers in different drawings may identify the same or similar elements. Also, the following detailed description does not limit the invention.

### Overview

Implementations consistent with the invention enable assignment of geographic location identifiers to web documents, such as web pages. In one implementation, geographic location identifiers included within web pages may be assigned to additional web pages that may or may not include geographic location identifiers based upon several relevancy criteria. In this manner, web pages that either do not include geographic descriptive information or include unrefined or incomplete geographic location information may nonetheless be searched or identified based on an assigned geographic location identifier. As described herein, document relevancy may be determined based on several factors, such as relative distance between documents, terminology used, and local or web site determination. Accordingly, geographic location identifiers may be accurately assigned to web documents.

A document, as the term is used herein, is to be broadly interpreted to include any machine-readable and machine-storable work product. A document may be an e-mail, a file, a combination of files, one or more files with embedded links to other files, a news group posting, etc. In the context of the Internet, a common document is a web page. Web pages often include content and may include embedded information (such as meta information, hyperlinks, etc.) and/or embedded instructions (such as Javascript, etc.).

### Exemplary Network Overview

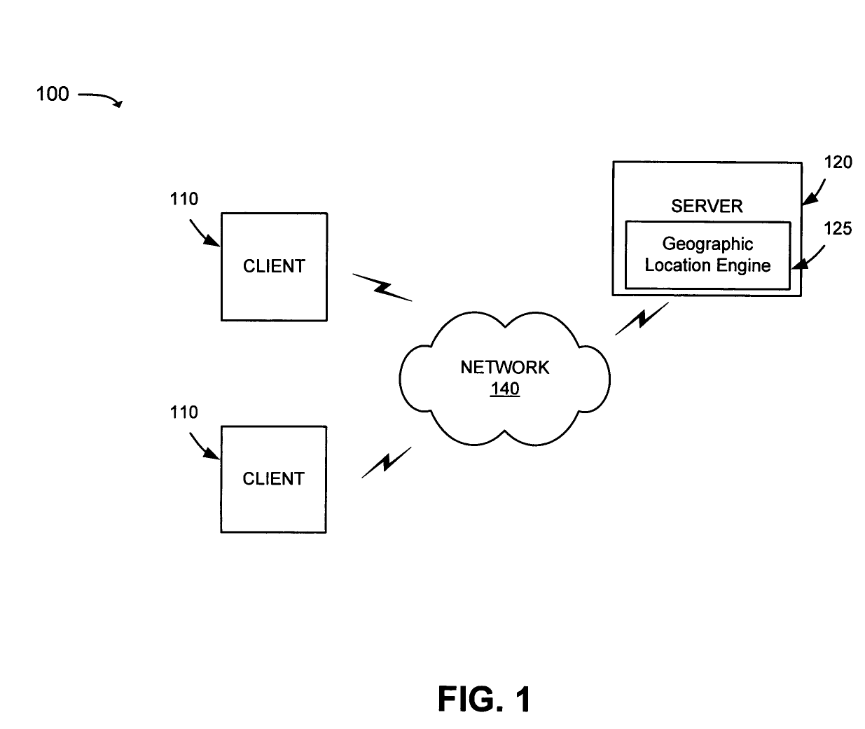

FIG. 1 is an exemplary diagram of a network 100 in which systems and methods consistent with the principles of the invention may be implemented. Network 100 may include multiple clients 110 connected to one or more servers 120 via a network 140. Network 140 may include a local area network (LAN), a wide area network (WAN), a telephone network, such as the Public Switched Telephone Network (PSTN), an intranet, the Internet, or a combination of networks. Two clients 110 and one server 120 have been illustrated as connected to network 140 for simplicity. In practice, there may be more clients and/or servers. Also, in some instances, a client may perform the functions of a server and a server may perform the functions of a client.

Clients 110 may include client entities. An entity may be defined as a device, such as a wireless telephone, a personal computer, a personal digital assistant (PDA), a lap top, or another type of computation or communication device, a thread or process running on one of these devices, and/or an object executable by one of these devices. Server 120 may include server entities that process, search, and/or maintain documents in a manner consistent with the principles of the invention. Clients 110 and server 120 may connect to network 140 via wired, wireless, or optical connections.

In an implementation consistent with the principles of the invention, server 120 may include a geographic location engine 125. In general, geographic location engine 125 may identify and assign geographic location identifiers to web sites available via network 140.

### Exemplary Client/Server Architecture

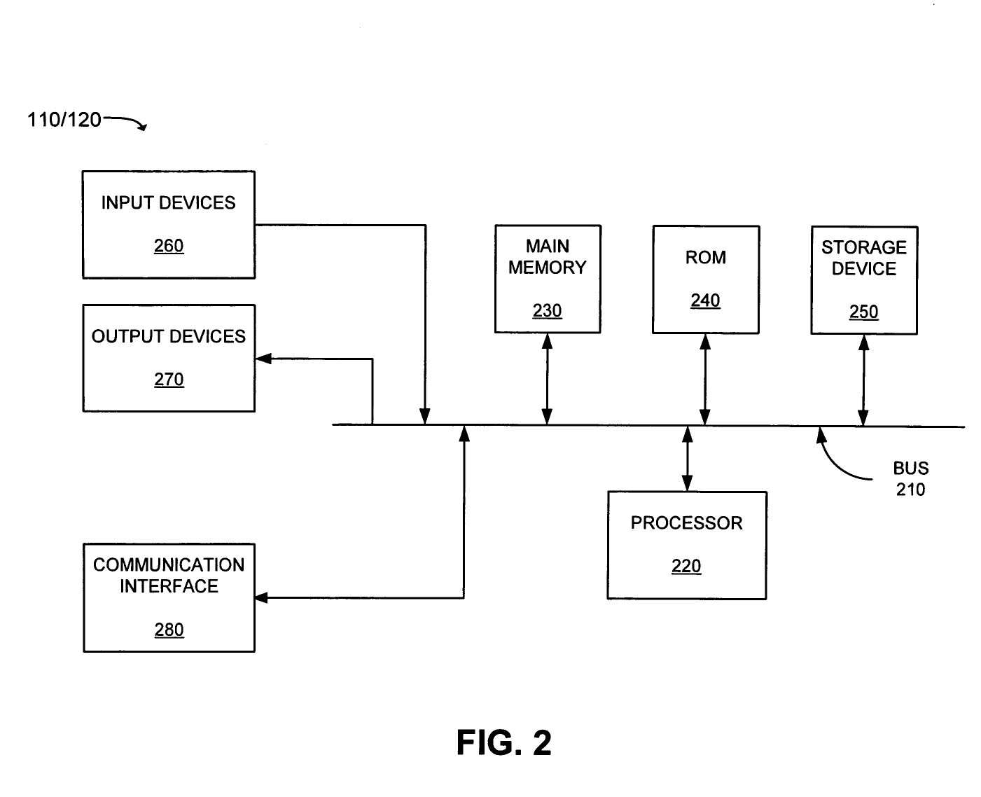

FIG. 2 is an exemplary diagram of a client 110 or server 120 according to an implementation consistent with the principles of the invention. Client/server 110/120 may include a bus 210, a processor 220, a main memory 230, a read only memory (ROM) 240, a storage device 250, one or more input devices 260, one or more output devices 270, and a communication interface 280. Bus 210 may include one or more conductors that permit communication among the components of client/server 110/120.

Processor 220 may include any type of conventional processor, microprocessor, or processing logic that interprets and executes instructions. Main memory 230 may include a random access memory (RAM) or another type of dynamic storage device that stores information and instructions for execution by processor 220. ROM 240 may include a conventional ROM device or another type of static storage device that stores static information and instructions for use by processor 220. Storage device 250 may include a magnetic and/or optical recording medium and its corresponding drive.

Input device(s) 260 may include one or more conventional mechanisms that permit a user to input information to client/server 110/120, such as a keyboard, a mouse, a pen, voice recognition and/or biometric mechanisms, etc. Output device(s) 270 may include one or more conventional mechanisms that output information to the user, including a display, a printer, a speaker, etc. Communication interface 280 may include any transceiver-like mechanism that enables client/server 110/120 to communicate with other devices and/or systems. For example, communication interface 280 may include mechanisms for communicating with another device or system via a network, such as network 140.

As will be described in detail below, server 120, consistent with the principles of the invention, may perform geographic document locating operations through geographic location engine 125. Geographic location engine 125 may be stored in a computer-readable medium, such as memory 230. A computer-readable medium may be defined as one or more physical or logical memory devices and/or carrier waves.

The software instructions defining geographic location engine 125 may be read into memory 230 from another computer-readable medium, such as data storage device 250, or from another device via communication interface 280. The software instructions contained in memory 230 causes processor 220 to perform processes that will be described later. Alternatively, hardwired circuitry may be used in place of or in combination with software instructions to implement processes consistent with the present invention. Thus, implementations consistent with the principles of the invention are not limited to any specific combination of hardware circuitry and software.

### Geographic Location Engine

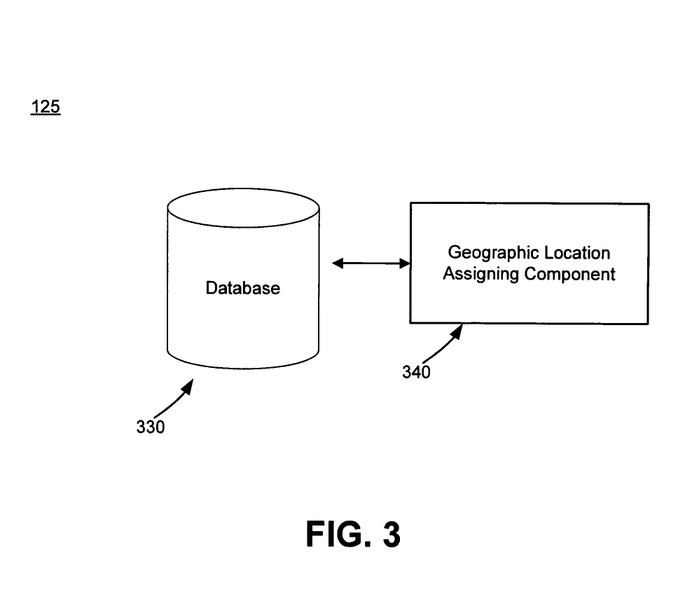

FIG. 3 is a block diagram illustrating an implementation of geographic location engine 125 in additional detail. Geographic location engine 125 may include a geographic location identifier assigning component 340. The documents on which geographic location identifier assigning component 340 operates may be stored in a database 330. Database 330 may be implemented in many different forms, such as a distributed database, a relational database, and so on. In one implementation, database 330 is generated from web documents available via the world wide web.

As discussed in additional detail below, geographic location identifier assigning component 340 may assign a geographic location identifier to the documents in database 330. Consistent with aspects of the invention, the geographic location identifier may be a partial or complete postal address, telephone number, area code, etc or any other suitable value associated with a physical geographic position, such as longitude and latitude. Moreover, consistent with principles of the invention, the geographic location identifier may be based on links, such as hyperlinks, that connect the nodes in the collection of documents in database 330.

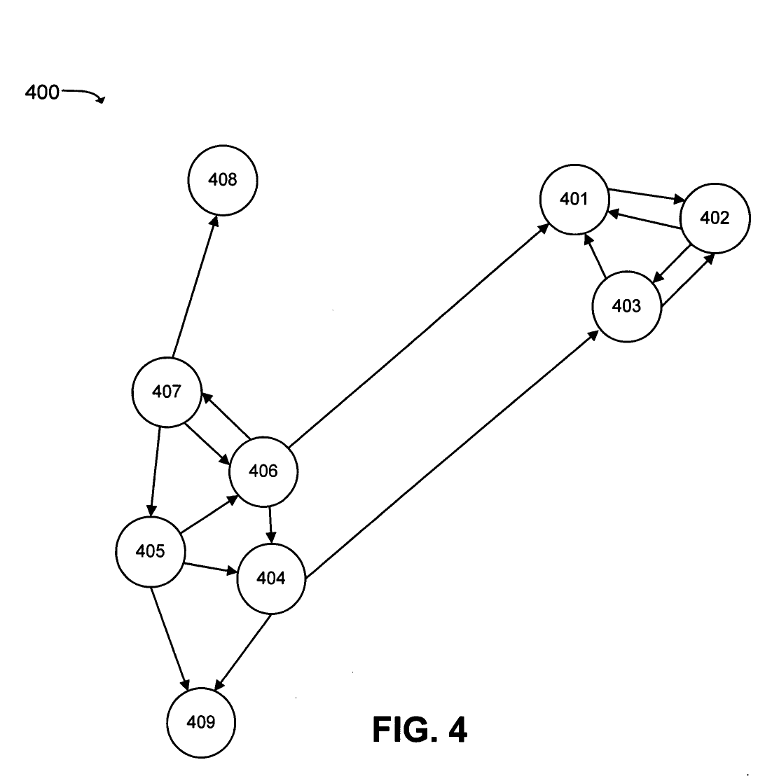

FIG. 4 is a diagram illustrating an exemplary set of documents 400 indexed by server 120. As previously mentioned, a document may refer to a web page or other searchable document. In practice, the set of documents 400 would generally be much larger than the set illustrated in FIG. 4. For example, database 330 may include many billions of documents. For ease of explanation, however, only nine documents, labeled as documents 401-409, are shown as being included in the set of documents 400.

The documents in set 400 can be thought of as forming a network graph in which each documents is connected by its respective links. When documents 400 represent web pages, the links may be in the form of hyperlinks. In FIG. 4, lines with arrows are used to indicate links. A line originating from a first document and leading to a second document may be called a forward or outbound link relative to the first document and indicate that the first document is a linking document. Similarly, a link from the first document to the second document may be characterized as a backlink from the second document to the first document. By characterizing links as backlinks, organization of hyperlinks pointing to and from a document may be more easily maintained. A line originating from the second document and leading to the first document may be called an inbound link relative to the first document and indicate that the first document is a linked document. Document 401, for example, has a single outbound link leading to document 402 and three inbound links originating from documents 402, 403, and 406.

### Exemplary Processing

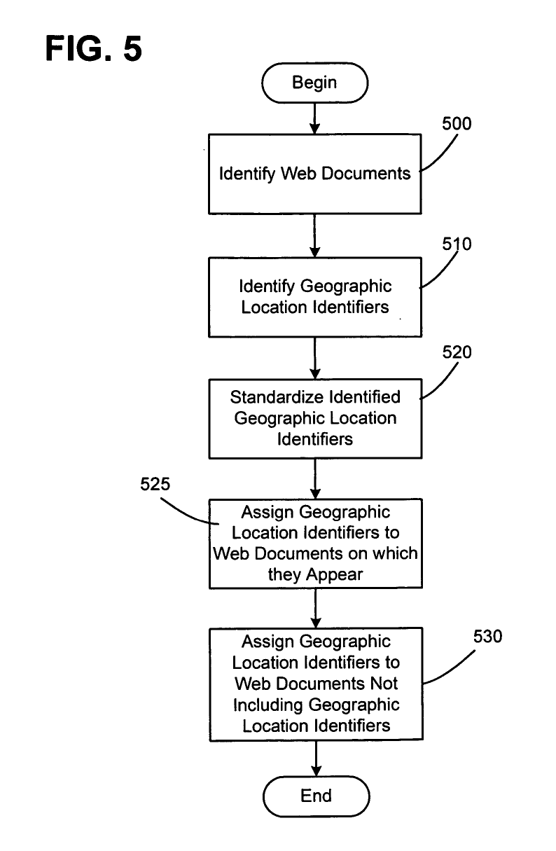

FIG. 5 is a flow diagram of an exemplary process for assigning geographic identification information to web documents included within search results provided to a client 110 in an implementation consistent with the principles of the invention. While the following description focuses on providing search results, it will be appreciated that implementations consistent with the principles of the invention are equally applicable to other types of information, besides search results. For example, implementations consistent with the principles of the invention are equally applicable to associating location identifiers to web documents referenced by or included within other sources, such as directories, etc.

Processing may begin by initially identifying, collecting, locating, or otherwise indexing a number of web documents, such as those in database 330 (act 500). In one implementation consistent with principles of the invention, web documents may be located and collected irrespective of a specific search query using, for example, automated search bots or web crawling technology. In one implementation consistent with principles of the invention, relational linking information for each document is also collected, indicating those documents that link to or from each collected document.

Geographic location identifiers appearing in the documents may then be identified (act 510). For example, a document may include a partial postal address, such as 1234 Anywhere Lane, Fairfax, Va. The partial address may be identified and associated with the document from which it was retrieved. In one implementation consistent with principles of the invention, suitable geographic location identifiers may include partial or complete postal addresses, although alternative geographic location identifiers may also be used, such as area codes, telephone numbers, airport codes, geographic landmark identifiers, etc. In one implementation consistent with principles of the invention, a pattern matching technique may be utilized for locating geographic location identifier. In such an implementation, the web documents may be examined for text that matches a standard format for an address, a partial address, a telephone number, etc. or additional terms that indicate the presence of geographic descriptive information.

The identified geographic location identifiers may then be standardized into a common, predefined format (act 520). For example, partial or non-standardized addresses failing to include zip codes may be standardized to include an appropriate zip code. Alternatively, identifiable misspellings or other errors or deficiencies may be corrected so as to ensure that the geographic location identifiers associated with a document are in an accurate, standardized format for each document. In one implementation consistent with principles of the invention, standardization may be used to identify geographic location identifier refinement and equality. Identifying geographic location identifier refinement refers to determining whether one geographic location identifier further narrows another geographic location identifier, such as 1234 Anywhere Drive, Fairfax, Va. further narrowing Fairfax, Va. Additionally, standardization may operate to extract information included with a geographic location identifier into predefined categories that may assist subsequent usage of the identifier. Such categories may include street number, street name, street type, city, state, county, country, zip code, etc.

Following geographic location identifier standardizing, a geographic location identifier may be initially assigned to web documents on which the geographic location identifier appears (act 524). Additionally, a geographic location identifier may be assigned to documents not already assigned or including a geographic location identifier or assigned a different geographic location identifier (act 530). In accordance with one implementation consistent with principles of the invention, such an assignment may be accomplished by assigning each document a geographic location identifier associated with another document which is linked, either directly or indirectly (through a predetermined number of links), to the document. Additional specifics regarding the assignment of geographic location identifiers will be set forth in additional detail below. Once a geographic location identifier has been associated with each document, the location identifiers may be used in performing subsequent searches or ranking of search results. Alternatively, results incorporating the documents may indicate the associated geographic location identifiers, thereby assisting users in sorting through the returned results.

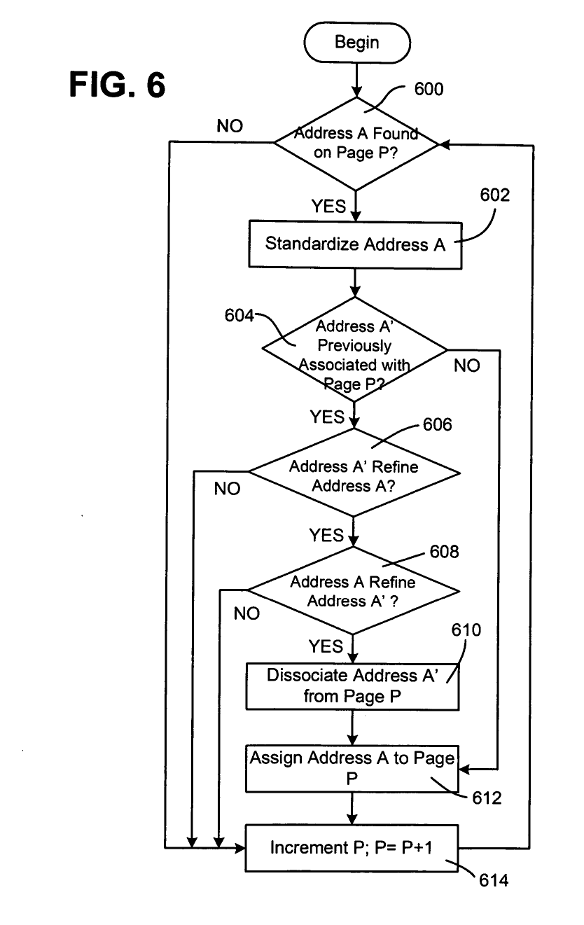

FIG. 6 is a flow diagram of an exemplary process for standardizing and assigning geographic location identifiers to a collection of web documents P in an implementation consistent with the principles of the invention. Initially, for each web document P, it is determined whether a partial or complete postal address A is found on the document (act 600). If no address is found, the process proceeds to act 614 described below. However, if an address A is found on document P, the address is standardized, as described above, to place the address into a consistent format (act 602). This may include data correction or supplementation, or any such suitable standardization technique.

It may also be determined whether an address A′ has been previously associated with document P (act 604). For example, an address A′ may have previously appeared on document P. If not, the process proceeds to act 612 described below. However, if an address A′ has been previously associated with document P, it is then determined whether address A′ either further refines address A (e.g., adds a street address to city, state information) or is equal to address A (act 606). If so, the process proceeds to act 614 described below, for processing of the next document. However, if it is determined that address A′ does not further refine address A and is not equal to address A, it is next determined whether address A refines address A′ (act 608). If address A further refines address A′, address A′ is then dissociated from document P (act 610) and address A is associated with document P (act 612). P is then incremented to P+1 (act 614) and the process returns to act 600 for examination of the next available document.

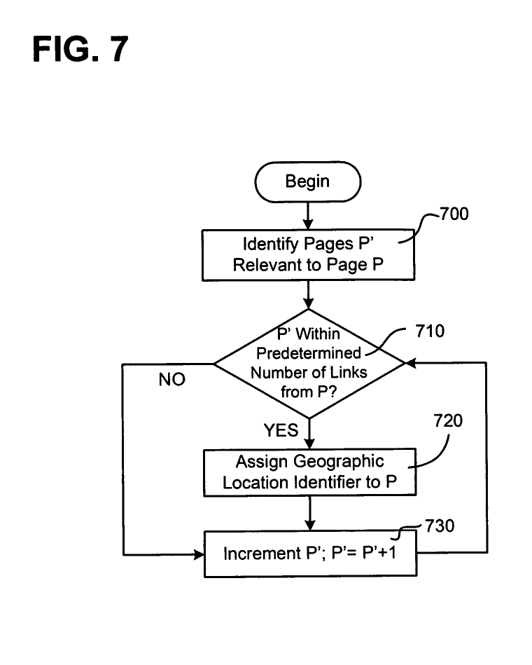

FIG. 7 is a flow diagram of an exemplary process for assigning geographic location identifiers to a collection of web documents P, in an implementation consistent with the principles of the invention. Initially, it is assumed that web documents having geographic location identifiers present thereon have already had those identifiers assigned to the document in accordance with the implementations set forth in detail above. Accordingly, the process may begin by identifying, for each document P, those documents P′ that include a geographic location identifier and are “relevant” to document P from a geographic identification standpoint (act 700).

In accordance with one implementation consistent with principles of the invention, “relevant” documents P′ may be defined as relevant to the question of the geographic location(s) of web site owners where 1) document P′ is “local” to document P, meaning that document P′ is a different document on the same web site as document P, and 2) the anchor appearing on document P linking to document P′ contains one or more terms from a small, heuristically determined set of terms. The term “anchor” refers to the part of an HTML hyperlink that is visible on a web document. For example, the text “Google” is the anchor of the following HTML hyperlink:<a href=“http://www.google.com/”>Google </a> Exemplary terms used in determining relevancy may include, but are not limited to, for example, “location(s)”, “direction(s)”, “find”, “finder”, “locate”, “locater”, “store(s)”, “branch(es)”, “about”, “company”, “contact”, “information”, etc. See below for more detail on this heuristically determined “relevance” of hyperlinks.

In another implementation consistent with principles of the invention, a link to a document P′ may be considered relevant if its anchor includes a complete or partial postal address. Alternatively, for images or other non-text object anchors, a document P′ may be considered relevant if its URL includes either a complete or partial postal address or any of the above listed terms.

In yet another implementation consistent with principles of the invention, a document P′ may be considered relevant by examining the contents of document P′ directly. For example, a hyperlink failing each of the above tests may still be considered “relevant” if the HTML title of the target document includes any of the terms listed above, or a complete or partial postal address. An actual implementation using this test would undoubtedly include in its first pass the detection of all web documents in the archive that pass this target document test. More detailed heuristics may be deployed to determine if the target document makes a hyperlink “relevant”.

Once at least one relevant document P′ has been identified, it is next determined whether document P′ is reachable within a predetermined number of links from document P (act 710). In one exemplary implementation, the number of links may be within the range of 2-5 links. If not, the process proceeds to act 730 for advancement to the next relevant document P′. However, if P′ is reachable within the predetermined number of links, the geographic location identifier(s) associated with document P′ may be associated with document P (act 720). The process then continues to act 730 where P′ is incremented to the next potentially relevant document (if any). The process then returns to act 710. By assigning geographic location identifier(s) from relevant web documents, the geographic location identifier(s) may be accurately associated with many more web documents, thereby enhancing the usefulness of these documents.

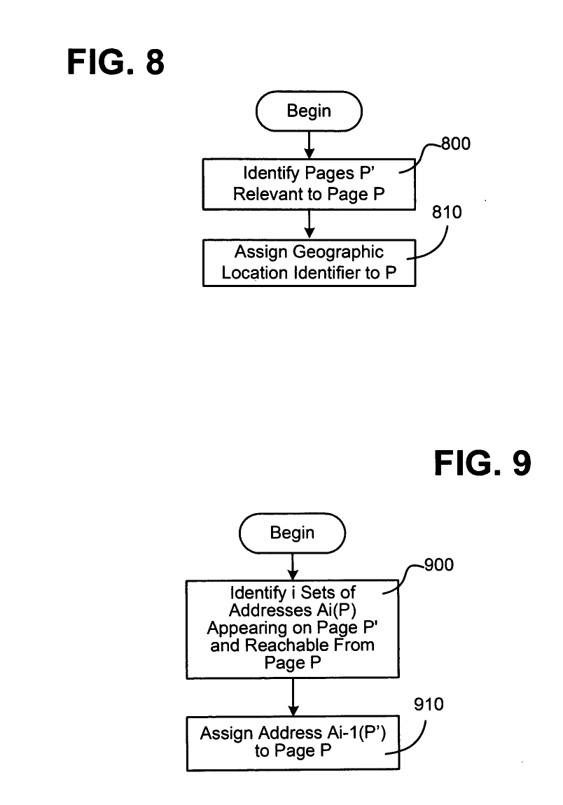

FIG. 8 is a flow diagram of another exemplary process for assigning geographic location identifiers to a collection of web documents P in an implementation consistent with the principles of the invention. Initially, at least one web document P is identified having at least one standardized geographic location identifier associated therewith, such as those described above, with respect to FIG. 6 (act 800). Next, for each document P, the geographic location identifier(s) associated with document P may be assigned to each relevant document P′ connected by a backlink from document P (act 810). As described above, relevancy may be determined heuristically, and may include those documents common to a particular web site and reachable within a predetermined number of backlinks. By starting from the document containing geographic location identifiers and working backwards, efficiencies may potentially be observed.

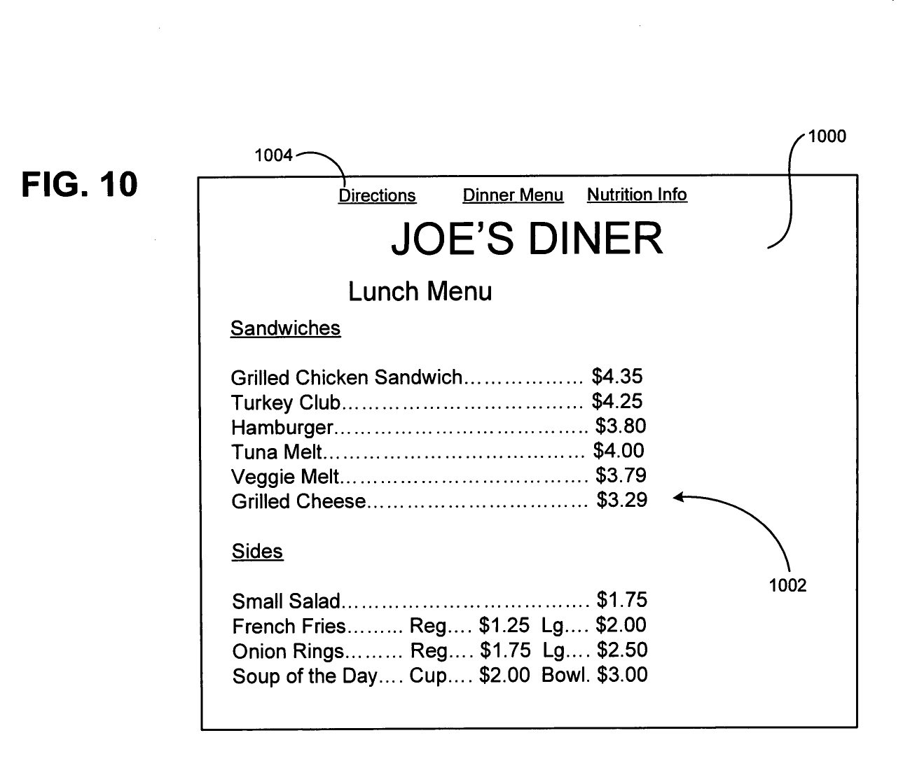

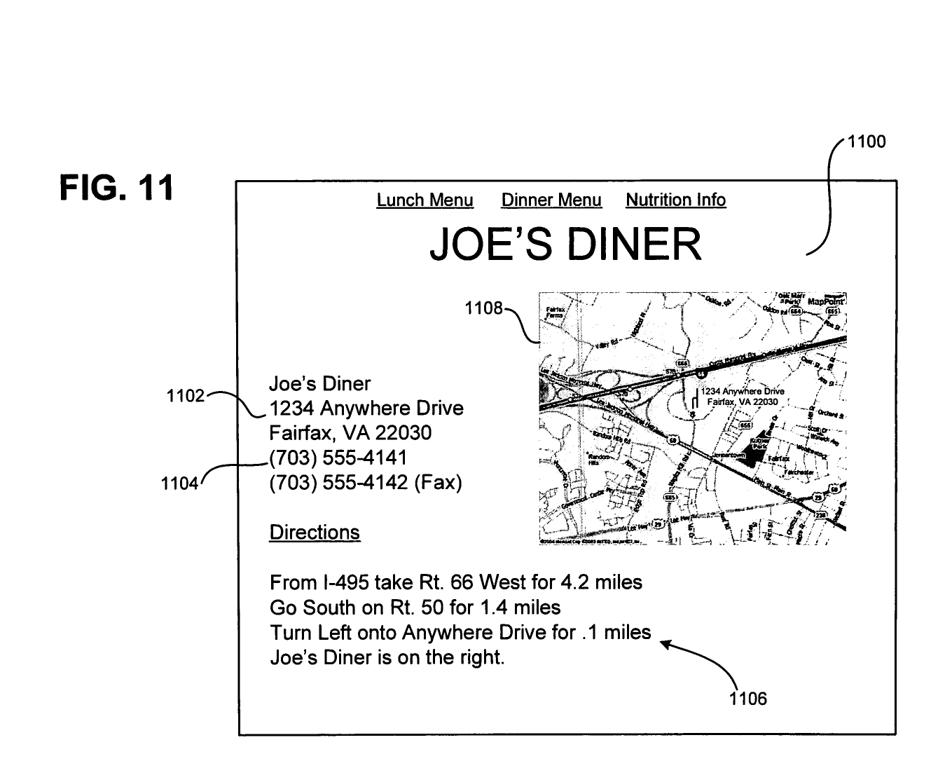

FIG. 9 is a flow diagram of yet another exemplary process for assigning geographic location identifiers to a collection of web documents P in an implementation consistent with the principles of the invention. Initially, i sets of postal addresses Ai(P) appearing on document P′ and reachable from document P following i “relevant” hyperlinks are identified (act 900). In this implementation, each set Ai(P) (for i from 0 to N, with N being the maximum number of links) includes addresses included on documents reachable from i links away and associated with document P. For example, in a scenario where N=3, four distinct Ai(P) sets, i.e., A0(P), A1(P), A2(P), and A3(P) are identified, where each set includes the addresses reachable from document P from the particular number of links away (e.g., 0-3). Next, for each relevant document P′ reachable from document P, addresses associated with document P′ one less link removed (e.g., Ai−1(P′)) are assigned to document P in the set associated with link distance i (e.g., Ai(P)) (act 910). In this alternative, all sets A1(P) through AN(P) are built for each document in turn by following “relevant” hyperlinks, but gain in performance by storing sets Ai(P′) computed for neighboring documents.

FIG. 10A is a graphical depiction of an exemplary web document 1000 that does not include geographic location identifiers directly usable in searching or otherwise identifying web document 1000 among a set of web documents. As shown in FIG. 10, web document 1000 may be a web page relating to a menu for “Joe's Diner” and may include various menu items 1002 including, e.g., a tuna melt sandwich. Accordingly, because web document 1000 does not include any geographic location identifiers, a search for “tuna melt” and “Fairfax, Va.” using a conventional search engine would fail to return web document 1000. However, in accordance with principles of the invention, a “Directions” link 1004 may point to an associated web document that does include a suitable geographic location identifier, e.g., address, telephone number, etc.

FIG. 10B is a graphical depiction of an exemplary web document 1100 associated with link 1004 on web document 1000 that includes geographic location identifiers. More specifically, such geographic location identifiers may include a business address 1102, a telephone number 1104. In addition web document 1100 may include driving directions 1106, and map 1108 for assisting users in accurately locating the business.

As described in detail above, one or more of geographic location identifiers 1102 and 1104 associated with web document 1100 may be assigned to web document 1000. In a manner consistent with principles of the invention, web document 1100 may be identified as “relevant” to web document 1000 because 1) it is “local” to web document 1000 in that it is part of the same web site, 2) link 1004 on web document 1000 associated with web document 1100 includes one or more of the geographically descriptive terms described above, and 3) web document 1100 is within a predetermined number of links removed from web document 1000 (one link, in this example). Accordingly, one or more of geographic location identifiers 1102 and 1104 associated with web document 1100 may be assigned to web document 1000, thereby facilitating searching of web document 1000 based on the one or more geographic location identifiers.

### CONCLUSION

Implementations consistent with the principles of the invention facilitate assignment of geographic location identifiers to web documents not including geographic location identifiers thereon.

The foregoing description of exemplary embodiments of the invention provides illustration and description, but is not intended to be exhaustive or to limit the invention to the precise form disclosed. Modifications and variations are possible in light of the above teachings or may be acquired from practice of the invention. For example, one or more of the acts described with respect to FIGS. 5-9 may be performed by server 120 or another device (or combination of devices). While a series of acts has been described with regard to FIGS. 5-9, the order of the acts may be varied in other implementations consistent with the invention. Moreover, non-dependent acts may be implemented in parallel.

It will also be apparent to one of ordinary skill in the art that aspects of the invention, as described above, may be implemented in many different forms of software, firmware, and hardware in the implementations illustrated in the figures. The actual software code or specialized control hardware used to implement aspects consistent with the principles of the invention is not limiting of the invention. Thus, the operation and behavior of the aspects of the invention were described without reference to the specific software code—it being understood that one of ordinary skill in the art would be able to design software and control hardware to implement the aspects based on the description herein.

Further, certain portions of the invention may be implemented as “logic” that performs one or more functions. This logic may include hardware, such as an application specific integrated circuit or a field programmable gate array, software, or a combination of hardware and software.

No element, act, or instruction used in the description of the invention should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

1. A method comprising:
identifying a plurality of web documents;
identifying geographic location identifiers included within at least some of the plurality of web documents; and
assigning the identified geographic location identifiers to web documents that include the geographic location identifiers; and
assigning the identified geographic location identifiers to other web documents based on a relevancy of the web documents that include a geographic location identifier to the other web documents.

2. The method of claim 1, wherein the web documents are web pages.

3. The method of claim 1, further comprising:
standardizing the identified geographic location identifiers into a predefined format.

4. The method of claim 3, wherein standardizing the identified geographic location identifiers comprises:
correcting errors in the identified geographic location identifiers.

5. The method of claim 3, wherein standardizing the identified geographic location identifiers comprises:
supplementing the identified geographic location identifiers with additional location identification information.

6. The method of claim 1, wherein the geographic location identifiers include postal addresses.

7. The method of claim 6, wherein the postal addresses include partial postal addresses.

8. The method of claim 6, wherein the geographic location identifier includes a telephone number.

9. The method of claim 1, wherein assigning the identified geographic location identifiers to other web documents comprises:
determining if a web document that includes a geographic location identifier is local to the other web documents.

10. The method of claim 9, wherein assigning the identified geographic location identifiers to other web documents comprises:
determining if a term associated with the web document that includes the geographic location identifier includes a term associated with geographic locations.

11. The method of claim 10, wherein assigning the identified geographic location identifiers to other web documents comprises:
determining if the web document that includes the geographic location identifier is linked to the web document that does not include a geographic location identifier within a predetermined number of links.

12. The method of claim 11, wherein assigning the identified geographic location identifiers to other web documents comprises:
assigning the geographic location identifier associated with the web document that includes the geographic location identifier to the other web documents if it is determined that the web document that includes the geographic location identifier is local to the other web documents, the term associated with the web document that includes the geographic location identifier includes a term associated with geographic locations, or the web document that includes the geographic location identifier is linked to the other web documents within a predetermined number of links.

13. The method of claim 9, wherein the term associated with the web document that includes the geographic location identifier is associated with a link anchor.

14. The method of claim 9, wherein the term associated with the web document that includes the geographic location identifier is associated with an HTML document title.

15. The method of claim 9, wherein the term associated with a geographic location includes at least one of: location, locations, direction, directions, find, finder, locate, locater, store, stores, branch, branches, about, company, contact, or information.

16. The method of claim 9, wherein the term associated with a geographic location includes at least a partial postal address.

17. The method of claim 9, wherein the predetermined number of links is approximately five links.

18. The method of claim 1, wherein assigning the identified geographic location identifiers to other web documents comprises:
determining if a web document that includes the geographic location identifier is local to the other web documents;
determining if the web document that includes the geographic location identifier is backlinked to the other web documents within a predetermined number of links; and
assigning the geographic location identifier associated with the web document that includes the geographic location identifier to the other web documents if it is determined that the web document that includes the geographic location identifier is local to the other web documents, and that the web document that includes the geographic location identifier is backlinked to the other web documents within a predetermined number of links.

19. The method of claim 1, comprising:
determining whether a first geographic location identifier has been previously assigned to a web document;
determining whether a second geographic location identifier refines the first geographic location identifier; and
replacing the first geographic location identifier with the second geographic location identifier if the second geographic location identifier refines the first geographic location identifier.

20. A system comprising:
means for identifying a plurality of web documents;
means for identifying a geographic location identifier included within a first web document in the plurality of web documents; and
means for assigning the identified geographic location identifier to a second web document in the plurality of web documents based on a relevancy of the first web document to the second web document.

21. The system of claim 20, wherein the means for assigning the identified geographic location identifier comprises:
means for assigning the geographic location identifier to the second web document if it is determined that the first web document is local to the second web document.

22. The system of claim 20, wherein the means for assigning the identified geographic location identifier comprises:
means for assigning the geographic location identifier to the second web document if it is determined that a term associated with the first web document includes a term associated with geographic locations.

23. The system of claim 20, wherein the means for assigning the identified geographic location identifier comprises:
means for assigning the geographic location identifier to the second web document if it is determined that the first web document is linked to the second web document within a predetermined number of links.

24. The system of claim 20, wherein the means for assigning the identified geographic location identifier comprises:
means for assigning the geographic location identifier to the second web document if it is determined that the first web document is local to the second web document, and that the first web document is backlinked to the second web document within a predetermined number of links.

25. The system of claim 20, comprising:
means for standardizing the identified geographic location identifier into a predefined format.

26. The system of claim 20, comprising:
means for determining whether a first geographic location identifier has been previously assigned to the second web document;
means for determining whether a second geographic location identifier refines the first geographic location identifier; and
means for replacing the first geographic location identifier with the second geographic location identifier if the second geographic location identifier refines the first geographic location identifier.

27. A server, comprising:
a memory to store instructions; and
a processor to execute the instructions to:
identify a geographic location identifier included within a first web document; and
assign the identified geographic location identifier to a second web document based on a relevancy of the first web document to the second web document.

28. A computer-readable medium containing instructions for controlling a processor to assign geographic location identifiers to web documents, comprising:
one or more instructions for identifying a geographic location identifier included within a first web document; and
one or more instructions for assigning the identified geographic location identifier to a second web document if it is determined that a term associated with the first web document includes a term associated with geographic locations.

29. The computer-readable medium of claim 28, further comprising:
one or more instructions for standardizing the identified geographic location identifier into a predefined format.
